(19) United States
(12) Patent Application Publication
(10) Pub. No.: US 2005/0225133 A1
(43) Pub. Date: Oct. 13, 2005

(54) Cheek plate for a rigid structure of a vehicle seat

(76) Inventors: Christophe Aufrere, Montlhery (FR); Alain Laporte, Guyancourt (FR); Dominique Cottin, Chilleurs Aux Bois (FR)

Correspondence Address: FISH & RICHARDSON PC, P.O. BOX 1022, MINNEAPOLIS, MN, 55440-1022, US

(21) Appl. No.: 11/101,168

(22) Filed: Apr. 7, 2005

(30) Foreign Application Priority Data
Apr. 13, 2004 (FR) 04 03847

(51) Int. Cl. A61C 5/00

(52) U.S. Cl. 297/216.1

(57) ABSTRACT

A cheek plate for a rigid structure of a vehicle seat, the cheek plate being constituted by a rigid plate having a central portion defined on either side by first and second side portions. The central portion has at least a first channel section, and the first side portion extends to a side end which is folded over and fastened against said first channel section so as to form at least a first box section.

The present invention relates to cheek plates for rigid structures for vehicle seats, to seats including such cheek plates, and to methods of manufacturing such cheek plates.

More particularly, the invention relates to a cheek plate for a rigid structure of a vehicle seat, the cheek plate being constituted by a rigid plate having a central portion defined on either side by first and second side portions.

### BACKGROUND OF THE INVENTION

Rigid structures for vehicle seats are generally covered with comfort padding which is itself covered with a trim cover for forming the seat proper or the seat back of the vehicle seat. Rigid seat structures, be they for a seat proper or for a seat back, must therefore withstand any mechanical stress caused by the presence of an occupant in the seat, in particular during an accident in which the vehicle is involved. A first solution for increasing the strength of the cheek plate consists in increasing the thickness of the rigid plate forming said cheek plate. However, that solution requires increasing the total weight of the cheek plate and thus of the rigid structure of the seat to a relatively large extent while correspondingly increasing the cost of manufacturing the seat.

### OBJECTS AND SUMMARY OF THE INVENTION

A particular object of the invention is to mitigate the above-mentioned drawbacks.

To this end, in accordance with the invention, a cheek plate for a rigid structure of a vehicle seat in question is wherein the central portion has at least a first channel section, and wherein the first side portion extends to a side end which is folded over and fastened against said first channel section so as to form at least a first box section.

By means of these provisions, the presence of at least one box section formed in one piece with the rigid plate by folding over the end of a side portion of the cheek plate onto the central portion thereof makes it possible to stiffen the cheek plate as a whole thereby increasing its resistance to mechanical stresses.

In preferred embodiments of the invention, it is optionally possible to make use of one or more of the following provisions:
the rigid plate is made of metal;
the side end of the first side portion is fastened in full to the first channel section so as to form a box section that is closed over its entire length;
the side end of the first side portion is fastened in part to the first channel section so as to form a box section that is open in part over its length;
the second side portion is folded over and fastened against the first channel section so as to form a second box section; and
the central portion has a second channel section against which the second side portion is folded over and fastened so as to form a second box section.

In addition, the invention also provides a vehicle seat including a rigid structure having two crosspieces which interconnect two side cheek plates adapted to be connected pivotally to another rigid structure of the seat, at least one of the side cheek plates being a cheek plate as defined above.

In addition, the invention also provides a method of manufacturing a cheek plate as defined above, which method consists in:
stamping out the central portion of the rigid plate for forming said first channel section;
disposing a body between the first channel section and the first side portion;
folding over the first side portion around said body by bringing said first side portion into contact with the first channel section so as to obtain the first box section which has a shape substantially complementary to the shape of said body;
removing the body from said first box section; and
fastening the first side portion of the rigid plate to the first channel section so as to form said cheek plate.

According to another characteristic of the method, the first side portion of the cheek plate is fastened to the first channel section by welding or by riveting.

### BRIEF DESCRIPTION OF THE DRAWINGS

Other characteristics and advantages of the invention appear from the following description of three embodiments thereof given by way of non-limiting example and with reference to the accompanying drawings, in which:

FIG. 1 is a diagrammatic side view of a motor vehicle seat equipped with at least one cheek plate of the invention;

FIG. 2 is a diagrammatic perspective view of a rigid structure of the seat of FIG. 1, provided with two side cheek plates in a first embodiment of the invention;

FIG. 3 is a cross-section view of the first embodiment of a cheek plate;

FIGS. 4 to 8 diagrammatically show the various steps of the method of manufacturing the first embodiment of a cheek plate of the invention;

FIG. 9 is a diagrammatic cross-section view of a second embodiment of a cheek plate of the invention;

FIG. 10 is a diagrammatic view of a third embodiment of a cheek plate of the invention;

FIG. 11 is a cutaway cross-section view according to projection XI-XI of the cheek plate in FIG. 10; and

FIG. 12 is a cutaway cross-section view according to projection XII-XII of the cheek plate in FIG. 10.

In the various figures, like references designate elements that are identical or similar.

### MORE DETAILED DESCRIPTION

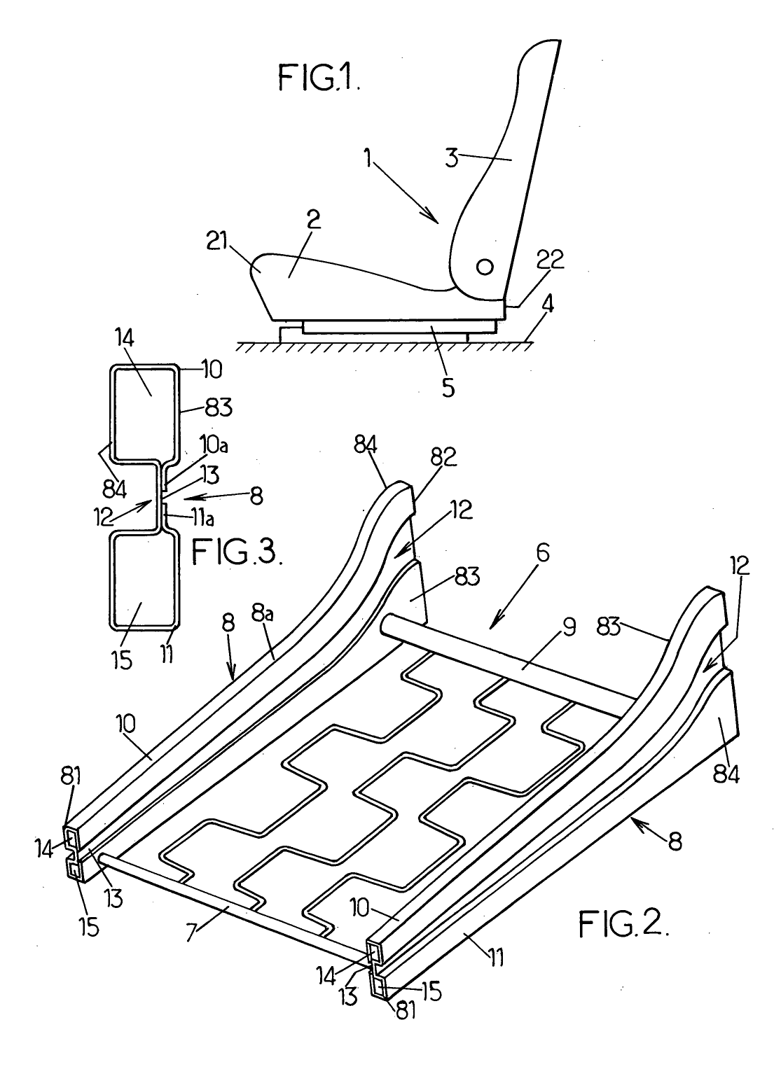

A seat 1 for a motor vehicle is shown in FIG. 1. In a manner known per se, this seat comprises a seat proper 2 and a seat back 3. The seat proper 2 extends longitudinally between a front end 21 remote from the seat back 3 and a rear end 22 close to said seat back 3. For example, the seat proper 2 is mounted to slide relative to a floor 4 of the motor vehicle via runners 5. In addition, the seat back 3 can also be mounted to pivot about a transverse axis relative to the seat proper 2 by means of a hinge system known per se.

As can be seen in FIG. 2, the seat proper 2 includes a rigid seat proper structure 6 on which foam padding (not shown in the drawings) is mounted that serves to provide comfort for a user of the seat. The rigid seat proper structure 6 has two rigid side cheek plates 8 which, in this example, are symmetrical to each other about the longitudinal direction. Each side cheek plate 8 extends in the longitudinal direction between a front end 81 remote from the seat back 3 and a rear end 82 that is designed to be connected to the seat back 3 of the seat by means of hinge systems (not shown). More exactly, the two side cheek plates 8 of the rigid seat proper structure 6 are connected to a rigid seat back structure which is provided with two side uprights that are connected together by a top crosspiece, and optionally by a bottom crosspiece. In addition, the two side cheek plates 8 are connected together at the front by a front crosspiece 7 and at the rear by a rear crosspiece or spacer 9.

Each side cheek plate 8 is constituted by a rigid plate 8a defined, in the example considered herein and in the vertical direction, by a first side portion 10 which corresponds to the top portion and by a second side portion 11 which corresponds to the bottom portion. The same rigid plate 8a that forms the side cheek plate 8 also has a central portion 12 disposed between the first and the second side portions 10, 11.

The central portion 12 and the first and the second side portions 10, 11 extend between the front end 81 and the rear end 82 of the side cheek plate 8.

In addition, the two side cheek plates 8 are provided with outside faces 84, and with inside faces 83 that are disposed facing each other.

As can be seen in more detail in FIG. 3, the central portion 12 of each side cheek plate 8 has a channel section 13 that projects towards the inside face 83, and thereby forms a channel in the outside face 84. The two side portions 10, 11 are folded over towards the inside face 83 so that their respective ends 10a, 11a come into contact with the projecting channel section 13. The ends 10a, 11a of the first and of the second side portions 10, 11 are fastened directly to the projecting channel section 13, e.g. by welding or by riveting. The ends 10a, 11a of the side portions 10, 11 can also be fastened by any other suitable means making it possible for said ends 10a, 11a to be fastened to the projecting channel section 13.

Thus, as can be seen in FIG. 3, fastening the side portions 10 and 11 to the channel section 13 of the central portion 12 makes it possible to form two box sections 14 and 15. In the first embodiment shown in FIGS. 2 and 3, the ends 10a, 11a of the first and of the second side portions 10, 11 are fastened over their entire lengths to the channel section 13 so that each cheek plate 8 is provided with two box sections 14, 15 which are closed over their entire length.

The two box sections 14, 15 formed from a single rigid plate 8a thus make it possible to obtain a side cheek plate 8 offering good resistance to mechanical stresses while also maintaining thickness that is relatively small compared with a conventional cheek plate which, in order to have the same strength characteristics would need to have a thickness that is much larger.

This cheek plate offers improved resistance to bending both in a vertical plane and in a horizontal plane, and also improved resistance to twisting.

In the first embodiment shown in FIG. 2, each projecting channel section 13 is formed so as to project relative to the inside face 83 of the side cheek plate 8 that is associated with it. Naturally, each channel section 13 can also be formed on the outside face 84, the ends 10a, 11a of the first and of the second side portions 10, 11 then being directly folded over towards the outside face 84 so as to be fastened to the projecting channel section 13.

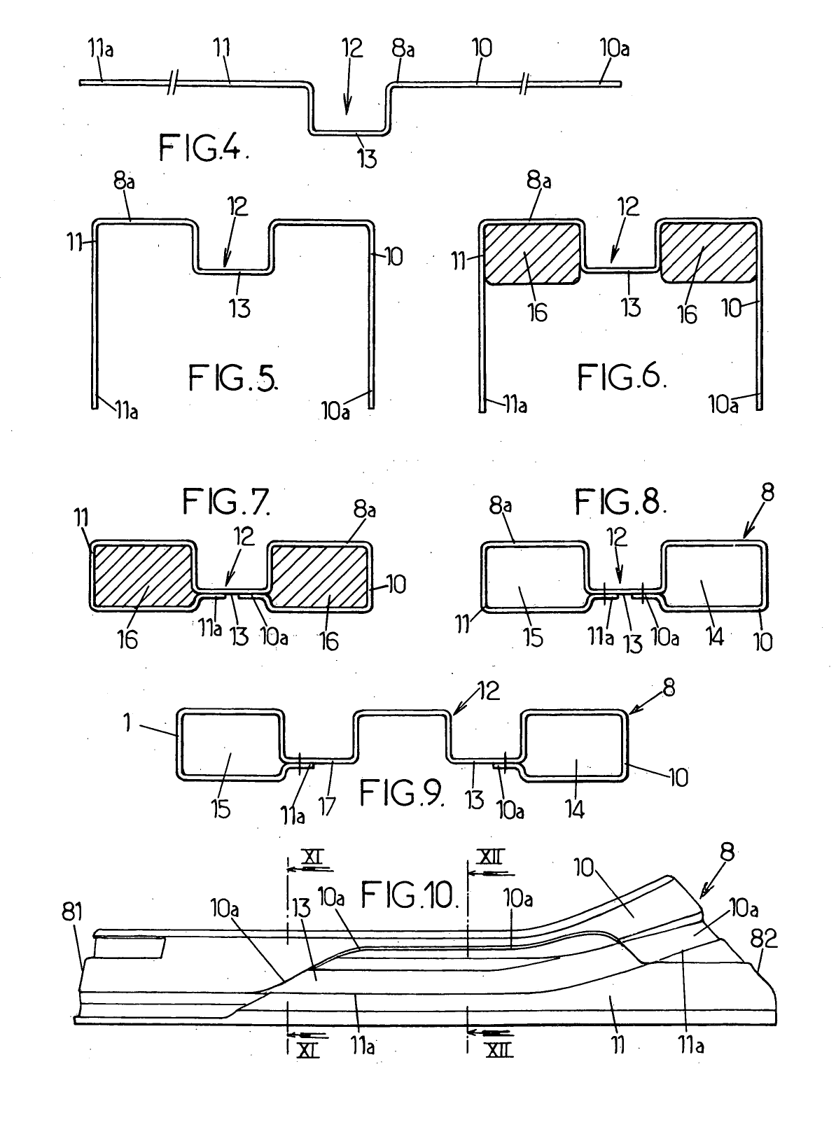

FIGS. 4 to 8 show the various steps of the method of manufacturing the side cheek plate 8 from the rigid plate 8a.

During a first step shown in FIG. 4, the rigid plate 8a is stamped out at its central portion 12 so as to form the projecting channel section 13. In a second step as shown in FIG. 5, the side portions 10 and 11 are folded over at an angle of about 90° in the example considered herein so as to dispose two bodies 16 one on either side of the projecting channel section 13 and between the first and the second side portions 10 and 11. Then, the two ends 10a, 11a of the first and second side portions 10, 11 are folded over against the bodies 16 so that said ends 10a, 11a come into contact with the projecting channel section 13 as shown in FIG. 7. Said bodies 16 can have predetermined shapes so as to impart the desired shapes to the side portions 10, 11 as folded over against the projecting channel section 13. Then, each body 16 can be extracted from the respective resulting recess so as finally to enable said ends 10a, 11a to be fastened against the projecting channel section 13, e.g. by welding or riveting as described above so as to form the box sections 14 and 15, thereby forming the cheek plate 8 of the invention. FIG. 9 shows a second embodiment of the invention. In the second embodiment, in addition to the first projecting channel section 13, the central portion 12 further has a second projecting channel section 17. In this case, the first side portion 10 or more exactly its end 10a is folded over directly and fastened to the first channel section 13 so as to form the box section 14 while the end 11a of the second side portion 11 is folded over and fixed against the projecting channel section 17 so as to form the second box section 15.

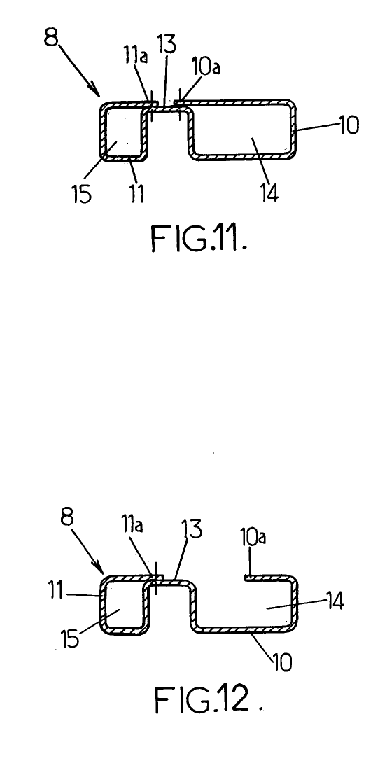

FIGS. 10 to 12 show a third embodiment of the invention. In this embodiment at least one of the side portions of the rigid plate 8a, e.g. the first side portion 10, has an end 10a that is curved so that said end 10a is fastened only in part, e.g. at two or three points, to the projecting channel section 13, thereby forming a box section 14 that is open in part as can be seen in FIG. 12, and closed in part along the longitudinal direction as can be seen in FIG. 11.

The above description given with reference to FIGS. 1 to 10 takes as an example forming a side cheek plate 8 of the rigid structure 6 of the seat proper 2. However, the invention is also applicable to side cheek plates or side uprights forming the rigid structure of the seat back 3.

1. A cheek plate for a rigid structure of a vehicle seat, the cheek plate being constituted by a rigid plate having a central portion defined on either side by first and second side portions, said cheek plate wherein the central portion has at least a first channel section, and wherein the first side portion extends to a side end which is folded over and fastened against said first channel section so as to form at least a first box section.

2. A cheek plate according to claim 1, in which the rigid plate is made of metal.

3. A cheek plate according to claim 1, in which the side end of the first side portion is fastened in full to the first channel section so as to form a box section that is closed over its entire length.

4. A cheek plate according to claim 1, in which the side end of the first side portion is fastened in part to the first channel section so as to form a box section that is open in part over its length.

5. A cheek plate according to claim 1, in which the second side portion is folded over and fastened against the first channel section so as to form a second box section.

6. A cheek plate according to claim 1, in which the central portion has a second channel section against which the second side portion is folded over and fastened so as to form a second box section.

7. A vehicle seat including a rigid structure having two crosspieces which interconnect two side cheek plates adapted to be connected pivotally to another rigid structure of the seat, at least one of the side cheek plates being a cheek plate according to claim 1.

8. A method of manufacturing a cheek plate according to claim 1, which method consists in:
stamping out the central portion of the rigid plate for forming said first channel section;
disposing a body between the first channel section and the first side portion;
folding over the first side portion around said body by bringing said first side portion into contact with the first channel section so as to obtain the first box section which has a shape substantially complementary to the shape of said body (16);
removing the body from said first box section (14); and
fastening the first side portion of the rigid plate to the first channel section so as to form said cheek plate.

9. A method according to claim 8, in which the first side portion of the cheek plate is fastened to the first channel section by welding or by riveting.
